(19) United States
(12) Patent Application Publication
(10) Pub. No.: US 2021/0003319 A1
(43) Pub. Date: Jan. 7, 2021

(54) INDIRECT GAS-FIRED CONDENSING FURNACE

(71) Applicant: Heatco, Inc., Cartersville, GA (US)

(72) Inventors: Eric R. Bruton, Cartersville, GA (US); Terrance C. Slaby, Canton, GA (US); Matthew W. Reese, Temple, GA (US)

(21) Appl. No.: 17/023,954

(22) Filed: Sep. 17, 2020

Related U.S. Application Data
(63) Continuation of application No. 15/004,180, filed on Jan. 22, 2016.
(60) Provisional application No. 62/106,916, filed on Jan. 23, 2015.

(51) Int. Cl. F24H 8/00; F24H 3/06

(52) U.S. Cl. CPC F24H 8/006; Y02B 30/00; F24H 3/065

(57) ABSTRACT

An indirect gas-fired condensing furnace assembly and method includes a primary heat exchanger, a secondary heat exchanger, and a tertiary heat exchanger. The secondary heat exchanger assembly may be an intermediate single-pass tubular heat exchange section made from a corrosion-resistant material. The tertiary heat exchanger assembly may be a single-pass tubular heat exchanger section with a corrosion resistant material. The tertiary heat exchanger assembly may include a plurality of fins. The primary heat exchanger assembly may include a plurality of aligned tubes wherein each tube includes a first straight portion, an intermediate portion, and a second straight portion such that the primary heat exchanger tubes surround the secondary and the tertiary heat exchanger assemblies such that the airflow is configured to traverse the primary heat exchanger assembly, the secondary heat exchanger assembly, and the tertiary heat exchanger assembly in various directions such that a risk of condensation freezing within the secondary and tertiary heat exchange assemblies is reduced.

### REFERENCE TO RELATED APPLICATIONS

The present application claims priority to U.S. patent application Ser. No. 15/004,180 filed on Jan. 22, 2016, which claims priority to U.S. Provisional Application No. 62/106,916 entitled “INDIRECT GAS-FIRED CONDENSING FURNACE WITH HIGH TURNDOWN” filed on Jan. 23, 2015, each of which is incorporated by reference herein in its entirety.

### FIELD OF INVENTION

The present disclosure generally relates to a condensing furnace system which is adapted to be installed in the ducting of an air handling system. More particularly, the present disclosure relates to the construction a gas-fired condensing furnace.

### BACKGROUND

Condensing furnaces have been used to improve heating efficiency versus conventional furnaces for a number of years in residential heating applications. Generally, conventional gas furnaces employ a burner to combust a gaseous fuel, a primary heat exchanger for transferring heat from combustion gases to the circulating air stream, and a blower to circulate return air from the space to be heated over the external surfaces of the heat exchanger and through a duct system, providing warm air to the home or structure. These furnaces often include an induced draft fan to draw out and vent the flue products from the primary heat exchanger. Condensing furnaces typically employ a secondary (recuperative) heat exchange section to transfer additional heat from the combustion products after they have passed through the primary heat exchanger thereby improving the operating efficiency of the furnace.

The main differences between a conventional furnace and a condensing furnace are the heat exchanger technology used to extract heat from the combustion process and the method used to exhaust the combustion gases. Conventional furnaces (mid-efficiency) only transfer sensible heat from the combustion products to the heat exchanger as they are cooled, limiting the maximum efficiency to 83%. Condensing furnaces not only transfer sensible heat but also transfer latent heat during condensation and achieve efficiencies greater than 90%.

Condensing furnaces provide a longer dwell time of heated flue gases than conventional furnaces, even to the point where the combustion exhaust gases “cool” and condense. This longer period of time has been accomplished by using two heat exchangers, one for a primary heat exchange and one for a secondary heat exchange. Combustion (flue) gases from the primary heat exchanger communicate with the secondary (recuperative) coil through a common flue gas collector box. The secondary heat exchanger handles the condensed exhaust gases of water and carbon dioxide. These exhaust gases may form corrosive fluids such as hydrochloric and sulfuric acid. The exhaust gases may be depleted of heat until the fluid condensate drains out of the heat exchanger and the flue gases are exhausted through a vent stack.

In the primary heat exchanger, only sensible heat is transferred from the combustion products as they are cooled, but the temperature of the combustion gases remain-above their dew point. This primary heat exchanger may be a plurality of tubes, shells, or a single cavity wherein combustion of the gaseous fuels occurs. This primary or leading heat exchanger assembly section is made from conventional heat exchanger materials (i.e., aluminized steel, 409 SS, 304 SS). The secondary (recuperative) heat exchanger is used to transfer additional heat from the combustion gases. This secondary heat exchanger cools combustion products sufficiently to condense a portion of the water vapor in the combustion products. Furnaces can thus achieve efficiencies exceeding 90% by condensing a portion of the water vapor produced as a standard by-product of the combustion process present in the combustion (flue) gases, thereby utilizing the latent heat of vaporization (972 Btu/lb. of water condensed).

High efficiency furnaces, however, are subject to corrosive attack as flue gases may form corrosive fluids such as hydrochloric and sulfuric acid. The condensate produced is acidic, typically with a pH in the range of 3.5-6.0, and readily attacks and corrodes conventional heat exchanger materials. The secondary (recuperative) heat exchanger is typically made from corrosion resistant materials such as high grade corrosion resistant stainless steel, with possible external fins attached to enhance heat transfer. Design and operation must ensure that condensation does not occur in the primary heat exchange section to avoid unsafe operation and premature failure. It should be noted that the primary mechanism for corrosion is wet-dry cycling which concentrates the corrosive elements. Areas that remain dry and areas that are continuously wetted are typically not subject to corrosive attack.

Commercial heating furnaces and duct furnaces are often located outdoors (weatherized), typically on rooftops and, therefore, are exposed to outdoor temperatures. Commercial products are also used to provide ventilation air (make-up air) to meet ASHRAE and EPA air quality requirements, and even if located indoors, the temperature of the circulating air is at outdoor temperatures typically below freezing during winter. In extreme northern climates, entering air may even be below 0° F. This provides a significant risk of freezing condensate in the secondary heat exchanger or condensate drain lines, particularly with the circulating air initially traversing the secondary heat exchanger section. In make-up air applications where the heating apparatus is located indoors, the heating apparatus may be exposed to different conditions, for example, to 100% outdoor air at outdoor ambient temperature or mixed outside air with return air at temperatures below 35° F. may be directed across the heat exchanger. These conditions may result in the quick reduction of flue gas temperatures as they traverse the heat exchanger. Additionally, in constant volume airflow conditions, such as in building ventilation, the flue gas temperatures may reduce quickly. These conditions provide the possibility of fluid condensate freezing within heat exchanger tubes.

In order to minimize the freezing risk involved in current “weatherized” (outdoor installations) heat exchanger designs for condensing operations, the supply airflow may be directed over a multiple pass primary heat exchange section first, and then through a secondary heat exchange section (recuperative coil) second. “Non-weatherized” (indoor installations) designs direct entering air flow over the secondary coil first, which is suitable for entering air temperatures that are above 35° F. The heat exchange sections in these applications are positioned relative to a circulating air fan within the system such that air flow is directionally limited to a single direction over the heat exchangers. Additionally, turndown may be limited by appliance design and airflow direction. “Turndown” is a ratio that refers to the operational range of a device and is defined as the ratio of the maximum heat output to the minimum level of heat output at which the heat exchanger may operate efficiently or controllably.

As an additional enhancement, commercial heating systems may operate with varying gas firing rates. Modulating furnaces provide improved annual fuel utilization efficiencies by maintaining nearly constant temperatures in the heated space by varying heat input based on measured temperatures of the supply (outdoor) air. Applications resembling variable air volume (VAV) and zoning systems allow air pressures in the building to remain stable by varying the supply air or directing air into different zones. Higher turndown is beneficial in these applications because the heat input can be matched with the varying supply of airflow to maintain the desired space temperatures and building pressures while operating within the furnace manufacturer's specifications.

In these designs, the turndown ratio may be about 4:1 or greater. This can result in reduced heat exchanger surface temperatures and reduced temperatures of the combustion gases inside the heat exchanger. It is desirable that the design of these weatherized furnaces maintain the temperatures of the combustion gases inside the primary heat exchange section to remain above their dew point to avoid excess condensation in said section even at reduced firing rates during modulated operation.

However, there have been issues with condensing furnaces related to the risk of condensate freezing and condensation developing in the unprotected leading (primary) heat section. Additionally, many condensing furnaces lack flexibility of design related to the entering air temperature and direction of airflow.

### SUMMARY

The present technology provides a heat exchanger assembly for a furnace (e.g., a duct furnace) that is suitable for use in weatherized and non-weatherized applications. The assembly can provide a high efficiency furnace. Additionally, in weatherized applications (e.g., outdoor or mixed outdoor/indoor environments) where the furnace may be exposed to cold temperatures, the present system may prevent freezing of condensation that develops in the system.

In one aspect, the disclosure relates to a condensing furnace assembly that includes a primary heat exchanger, a secondary heat exchanger, and a tertiary heat exchanger. The condensing furnace may further include a burner assembly, a manifold assembly, and a combustion air device. The secondary heat exchanger assembly may be an intermediate single-pass tubular heat exchange section made from a corrosion-resistant material. The tertiary heat exchanger assembly may be a single-pass tubular heat exchanger section made from a corrosion resistant material. The tertiary heat exchanger assembly may include a plurality of fins. The primary heat exchanger assembly may include a plurality of aligned tubes wherein each tube includes a first straight portion, an intermediate portion and a second straight portion such that the primary heat exchanger tubes surround the secondary and the tertiary heat exchanger assemblies.

The primary heat exchanger assembly, the secondary heat exchanger assembly, and the tertiary heat exchanger assembly may be oriented such that airflow traverses a first direction over the first straight portion of the primary heat exchanger tubes through the secondary and tertiary heat exchanger assemblies to the second straight portion of the primary heat exchanger tubes. Additionally, the airflow direction may be bi-directional such that the airflow may be switched to traverse a second direction over the second straight portion of the primary heat exchanger tubes through the secondary and tertiary heat exchanger assemblies to the first straight portion of the primary heat exchanger tubes. The airflow may be configured to traverse the primary heat exchanger assembly, the secondary heat exchanger assembly, and the tertiary heat exchanger assembly in various directions such that a risk of condensation freezing within the secondary and tertiary heat exchanger assemblies is reduced.

In make-up air applications where the heating apparatus is located indoors, the heating apparatus may be exposed to different conditions, for example, 100% outdoor air at outdoor ambient temperature or mixed outside air with return air at temperatures below 35° F. may be directed across the heat exchanger. The present technology may protect from condensation forming in the primary heat exchange sections at high modulated inputs, further extending the life of the heat exchanger.

The heat exchanger, furnace design provides for high efficiency and continuous condensing operation (90%+efficiency) for applications in weatherized and non-weatherized locations.

Also provided is a method of operating a condensing furnace assembly configured to reduce the risk of condensate freezing. The method includes providing a condensing furnace assembly that includes a primary heat exchanger assembly including a plurality of aligned tubes wherein each tube includes a first straight portion, an intermediate portion, and a second straight portion, a secondary heat exchanger assembly including a plurality of aligned tubes, and a tertiary heat exchanger assembly including a plurality of aligned tubes wherein the primary heat exchanger tubes surround the secondary and the tertiary heat exchanger assemblies. Combustion gases are introduced into and through the primary heat exchanger assembly, the secondary heat exchanger assembly, and the tertiary heat exchanger assembly from a burner assembly such that at least a portion of the combustion gases are converted into a condensate liquid. An airflow is traversed over the heat exchangers in a first direction relative to the condensing furnace.

The burner assembly may be modulated to combust gas above a dew point temperature of exhaust gases of the combustion gases wherein the combustion gases are introduced into and through the primary heat exchanger assembly above the dew point temperature while the airflow traverses over the primary heat exchanger assembly. The airflow may optionally traverse over the heat exchangers in a second direction, opposite the first direction relative to the condensing furnace. The airflow traversing over the heat exchanger assemblies may include a temperature that is less than 32° F. and more particularly that is less than 0° F. A combustion air device may be modulated to draw the combustion gases through the primary heat exchanger assembly, secondary heat exchanger assembly and tertiary heat exchanger assembly such that the combustion gases are exhausted as exhaust gases from the furnace assembly. A portion of the combustion gases may be converted into the condensate liquid as the combustion gas in within the secondary heat exchanger or tertiary heat exchanger. The condensing furnace may be maintained to operate at a turndown ratio of about 5 to 1.

### BRIEF DESCRIPTION OF THE DRAWINGS

Operation of the disclosure may be better understood by reference to the following detailed description taken in connection with the following illustrations, wherein:

FIG. 1 is a perspective view of an embodiment of a condensing furnace of the present disclosure.

FIG. 2 is a top view of the condensing furnace of the present disclosure.

FIG. 3 is a front view of the condensing furnace of the present disclosure.

FIG. 4 is a front view with a partial cutaway view of the condensing furnace of the present disclosure.

FIG. 5 is a side view of the condensing furnace of the present disclosure.

FIG. 6 is a side view of the condensing furnace of the present disclosure.

FIG. 7 is a top view of an embodiment of the condensing furnace of the present disclosure.

FIG. 8 is a top view of an embodiment of a cabinet or housing of the condensing furnace of the present disclosure.

### DETAILED DESCRIPTION

Reference will now be made in detail to embodiments of the present disclosure, examples of which are illustrated in the accompanying drawings. It is to be understood that other embodiments may be utilized and structural and functional changes may be made without departing from the respective scope of the disclosure. Moreover, features of the various embodiments may be combined or altered without departing from the scope of the disclosure. As such, the following description is presented by way of illustration only and should not limit in any way the various alternatives and modifications that may be made to the illustrated embodiments and still be within the spirit and scope of the disclosure.

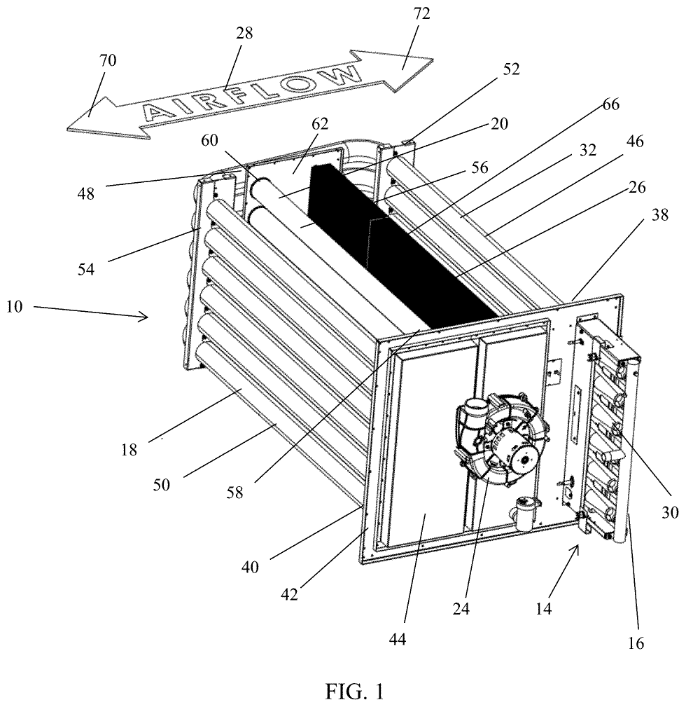

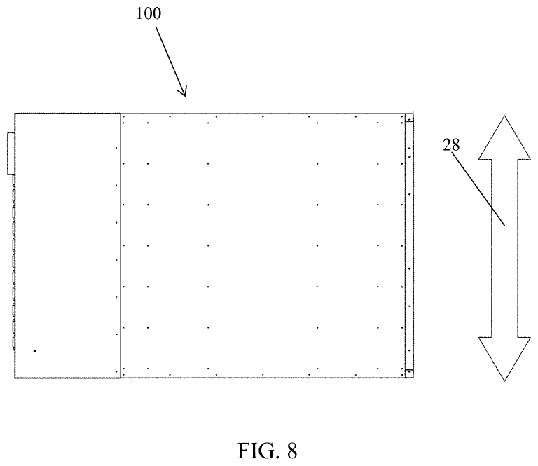

FIG. 1 illustrates a condensing furnace 10 which includes a primary heat exchanger, a secondary heat exchanger, and a tertiary heat exchanger. At least a portion of the furnace 10 may be used within a cabinet 100 (FIG. 8) or housing ductwork to be aligned within the line of an airflow 28 to be conditioned. The furnace 10 may include a burner assembly 14, a manifold assembly 16, a primary heat exchanger assembly 18, a secondary (intermediate) heat exchanger assembly 20, combustion air device 24, and a recuperative coil 26. The recuperative coil 26 may be considered a tertiary heat exchanger assembly. The secondary heat exchanger assembly 20 may be an intermediate single-pass tubular heat exchange section that provides a corrosion-resistant heat exchange element.

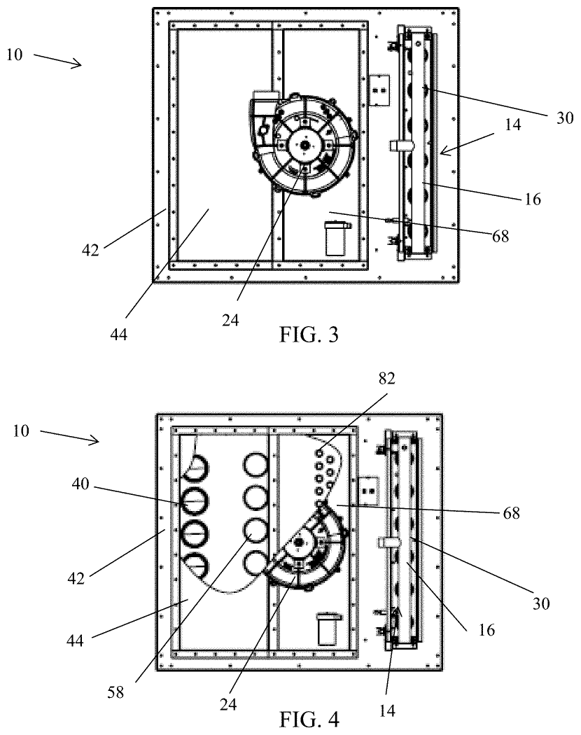

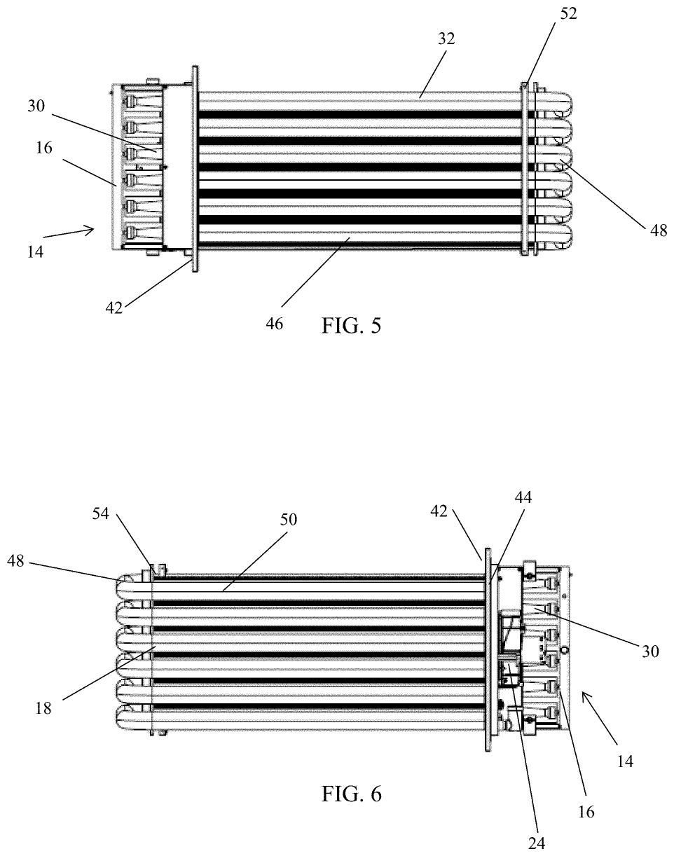

As illustrated by FIGS. 1-6, the condensing furnace 10 may be arranged with the described assemblies to be placed within an enclosure 100 that is in communication with the airflow 28 through a ventilation system (not shown). The ventilation system may include, for example, ductwork that handles the airflow of an HVAC system of a building.

The primary heat exchanger assembly 18, the secondary heat exchanger assembly 20, and the tertiary heat exchanger assembly 26 may be oriented within a ventilation system such that airflow 28 can traverse the respective disclosed assemblies in various directions while operating in conventional working parameters with a reduced risk of condensation freezing within the secondary and tertiary heat exchange assemblies 20 and 26.

Burner assembly 14 includes the manifold assembly 16 having a plurality of burners 30. The primary heat exchange assembly includes a plurality of tubes 32, one for each respective burner 30. The burners 30 receive fuel gas from manifold assembly 16 and inject the fuel gas into respective primary heat exchanger tube inlets 38. The embodiment illustrated by FIG. 1 includes six (6) tubes 32 along with six (6) burners 30. However, this disclosure is not limited as to the amount of primary tubes 32 or burners 30. It should be understood that the number of primary heat exchanger tubes 32 and corresponding burners 30 may be selected as desired for a particular application or intended use. For example, the number of burners 30 and heat exchanger tubes 32 may be chosen based on the required heating capacity of the furnace. A part of the injection process includes drawing air into primary heat exchanger assembly 18 so that the fuel gas and air mixture may be combusted therein.

Each primary heat exchanger tube 32 has a flow path which connects the primary heat exchanger inlets 38 in fluid communication to respective primary heat exchanger outlets 40. Each of the plurality of primary heat exchanger tubes 32 may include a first straight portion 46, an intermediate portion 48, and a second straight portion 50 that are generally aligned with one another in a general U-shaped configuration. The primary heat exchanger tubes 32 may be configured such that the straight portions 46 and 50 surround and may be generally aligned with the secondary and tertiary heat exchanger assemblies 20 and 26 along an airflow path 28 wherein the first straight portions 46 are adjacent the tertiary heat exchanger assembly 26 and the second straight portions 50 are adjacent the secondary heat exchanger assembly 20.

In this particular flow path configuration, the inlets 38 and the outlets 40 of the primary heat exchanger tubes 32 may be in communication with a tube sheet (vestibule panel) 42. Additionally, the inlets 38 and outlets 40 may be generally aligned along a common plane along the tube sheet (vestibule panel) 42. The burner assembly 14 may be mounted to an opposite side of the tube sheet (vestibule panel) 42 than the primary heat exchanger tubes 32 such that the burners 30 are configured to communicate with the inlets 38.

The plurality of first straight portions 46 attach to the plurality of intermediate portions 48 and may be supported by a first spacer member 52. The plurality of intermediate portions 48 attach to the plurality of second straight portions 50 and may be supported by a second spacer member 54. The spacer members 52 and 54 are configured to align and space each of the tubes 32 in a desired U-shaped orientation.

The combustion gas enters the inlets 38 and exits the outlets 40 (FIG. 4) and flows into a first coupling box 44. The first coupling box 44 may also be in fluid communication with the secondary heat exchanger assembly 20. The secondary heat exchanger assembly 20 includes a plurality of secondary heat exchanger tubes 56. The plurality of secondary tubes 56 may each include inlets 58 (FIG. 4) opening into the first coupling box 44 and a plurality of outlets 60 opening into a second coupling box 62. The secondary heat exchanger assembly 20 may be positioned between the first straight portions 46 and the second straight portions 50 of the primary heat exchanger tubes 32. The length of the intermediate portion 48 may be greater than a length of the second coupling box 62 to allow the primary heat exchanger tubes 32 to surround the second coupling box 62.

The combustion gas then enters the inlets 58 (FIG. 4) and exits the outlets 60 and flows into the second coupling box 62. The second coupling box 62 may also be in fluid communication with the tertiary heat exchanger assembly 26. The tertiary heat exchanger assembly 26 may include a plurality of finned tubes 66, each tube including an inlet end 80 and an outlet 82 (FIG. 4) wherein the outlet 82 is in communication with a third coupling box 68 positioned along an opposite side of the tube sheet (vestibule panel) 42. The configuration of the tertiary tubes 66 including the surface configuration may be chosen as desired for a particular purpose or intended application. In one embodiment, the tertiary heat exchanger 26 may comprise tubes with a generally smooth exterior surface. In another embodiment, the tubes of the tertiary heat exchanger may comprise contours, projections, or protuberances, for example, the tubes may include a plurality of fins. The shape, size, and spacing of the fins are not particularly limited and may be selected as desired. The tertiary heat exchanger assembly 26 may be positioned adjacent to the secondary heat exchanger assembly 20. The tertiary heat exchanger assembly 26 may be positioned between the first straight portions 46 and the second straight portions 50 of the primary heat exchanger tubes 32. The first coupling box 44 and the third coupling box 68 may be adjacent to one another on the tube sheet (vestibule panel) 42. The first, second, and third coupling boxes each define cavities such that the cavities are generally separate from one another but may remain in communication through the inlets and outlets of the primary, secondary, and tertiary heat exchanger assemblies.

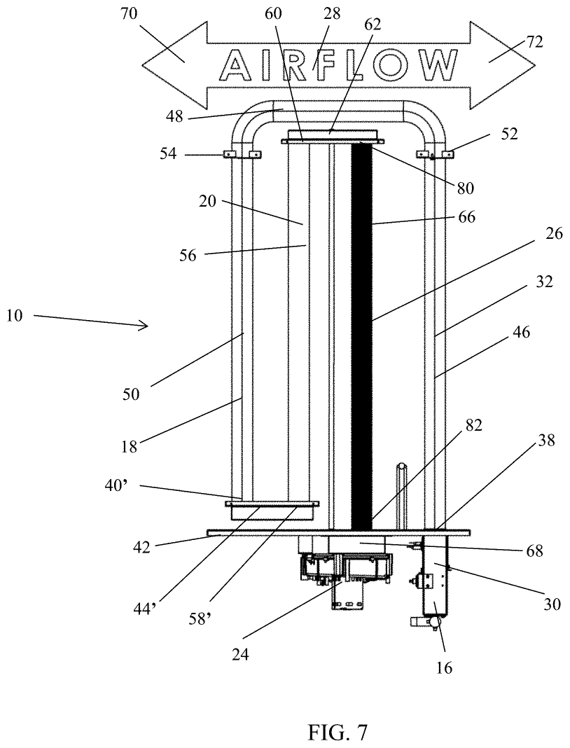

In one embodiment, as illustrated by FIG. 7, a first coupling box 44′ may be opposite from the third coupling box 68 relative to the tube sheet 42. In this embodiment, the first coupling box 44′ is located interior from the tube sheet 42 and within the airflow 28 while the third coupling box 68 is outside of the airflow 28 and positioned along the opposite side of the tube sheet 42. Additionally, the first coupling box 44 may be separate from tube sheet (vestibule panel) 42. Here, an outlet 40′ and an inlet 58′ may remain in communication with the first coupling box 44 separate from the tube sheet (vestibule panel) 42.

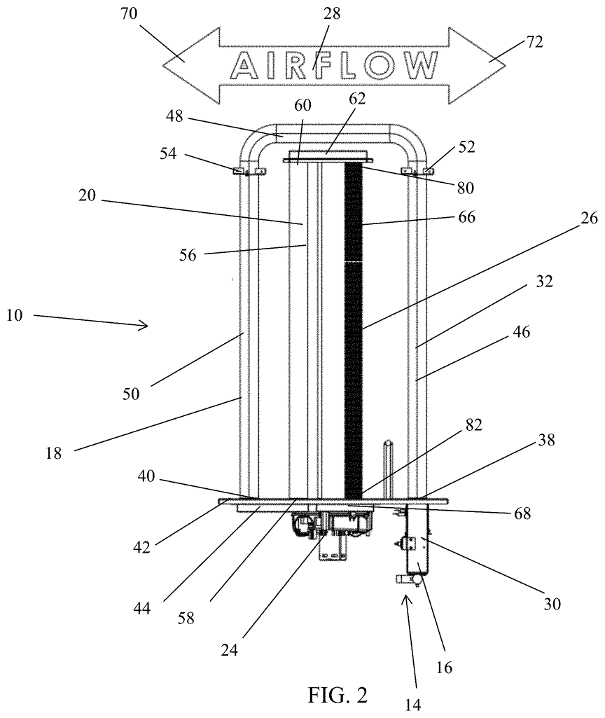

As illustrated by FIGS. 1 and 2, the airflow 28 of the HVAC system may traverse the heat exchanger assemblies in a first direction 70 or a second direction 72 opposite the first direction. The first coupling box 44 and second coupling box 62 receive heating fluid exhaust or flue gases condensate as it travels through the primary, secondary, and tertiary heat exchanger assemblies.

The combustion air device 24 may be an induced draft motor assembly that includes a motor with an inducer wheel for drawing the heating fluid exhaust or flue gases created by the burner assembly 14 through primary heat exchanger assembly 18, first coupling box 44, secondary heat exchanger assembly 20, second coupling box 62, tertiary heat exchanger assembly 26, and the third coupling box 68, thereafter exhausting to a flue duct and condensate drain (not shown). Notably, at least a portion of this configuration may be contained within a housing configured to allow the heat exchangers 18, 20, and 26 to be in communication with the airflow 28 as it traverses the arrangement of heat exchangers.

In operation, the primary heat exchanger 18 receives the highest temperature combustion flue gases from the burner(s). The combustion flue gases remain above the dew point temperature even as heat is transferred to the air as it traverses over the exterior surfaces of the heat exchanger tubes. The primary heat exchanger 18 may be made of conventional heat exchanger materials such as an aluminized coated steel tube system. The secondary heat exchanger 20 may include tubes having a smaller sized diameter or cross sectional area than those of the primary heat exchanger 18 and receive the exhaust gases once they have gone through the primary heat exchanger 18. The tertiary heat exchanger 26 receives the exhaust gases once they have gone through the primary and secondary heat exchangers 18 and 20. The tertiary heat exchanger tubes may include tubes having a smaller sized diameter or cross sectional area than those of the primary and secondary heat exchanger tubes. Here, more heat is extracted from the exhaust gases and as a result the gases may be cooled to the point that they condense into water, carbon dioxide, and other chemical exhaust materials. These exhaust materials may form an acidic condensate such as hydrochloric and sulfuric acid. Therefore, the secondary and tertiary heat exchangers 20 and 26 may be made of a non-corrosive material in order to resist corrosion, for example, proprietary stainless steel alloys such as super ferritic stainless steel such as AL 29-4C® provided by Allegheny Technologies Inc. (ATI).

The condensing furnace may include a two stage or dual stage burner assembly 14 with electronic controls that allow the burner flame to be on at a high and a low setting depending on the level of heat required. Additionally, the burner assembly 14 may have a modulating or variable capacity gas valve having an electronic control system for the burner and combustion air device 24 that allows very fine adjustments to the burner setting and blower motor speed, modulating them to keep the temperature of the heated space very close to a thermostat setting or maintain a desired supply air temperature for ventilation air provided to the space.

In this configuration, the condensing furnace 10 extracts useful heat even after the combustion exhaust gases have “cooled” through the primary heat exchanger assembly 18. This may be accomplished by the secondary and tertiary heat exchangers, wherein a portion of the water vapor contained in the flue gases entering the secondary heat exchanger 20 and tertiary heat exchanger 26 are condensed into a condensate fluid as heat is extracted from the flue gases in these sections.

The condensate fluid resulting from the gases flowing through the secondary and tertiary heat exchanger 20 and 26 may be drained and may be discharged through a drain pipe such as a plastic PVC pipe. The condensate may be acidic and may attack and corrode the furnace body or any other metal with which it comes in contact. Additionally, the condensing furnace flue exhaust gases may be relatively cool and can be vented from the combustion air device 24 with a plastic vent pipe such as an ABS or CPVC pipe because of their low temperature of around 120° F. or less.

The disclosed assembly, when coupled with a combustion air fan, is utilized to heat an external flow of air delivered to a conditioned space. The entering airflow direction may be in the first or second direction and the entering air temperature may be variable. The entering air is directed over either the first straight 46 or the second straight 46 of the primary heat exchanger tubes 32 prior to flowing over the secondary or tertiary heat exchangers.

This condensing furnace assembly 10 may maintain internal thermal fluid and tube surface temperatures above the dew point of the exhaust materials in the primary heater tube section. Corrosion-resistant tubing materials may be utilized in the secondary and tertiary heat exchanger assemblies, where condensing of water vapor in flue gases occurs. The tertiary heat assembly 26 may also include finned tubes to provide additional heat transfer surface to external circulating fluid and further reduce the temperatures of the internal flue gases.

The condensate produced by the combustion of gaseous fuels (i.e., natural gas, propane gas, etc.) however is acidic and corrosive (approximately 3.5-6.0 pH) even to most stainless steel materials. In the disclosed design, the secondary and tertiary heat exchangers may be made from materials which resist corrosive attack from this condensate.

The secondary and tertiary heat exchangers 20 and 26 may be encompassed by the primary heat exchanger assembly 18 to allow for heating of the airflow before flowing over the condensing sections, while allowing for supply airflow to be bi-directional. Airflow may be preheated by entering air passing over the first straight 46 or the second straight 50 of the primary heater exchanger tubes 32 before flowing over the secondary and/or tertiary heat exchanger assemblies 20 and 26 where condensation occurs. This configuration increases the external airflow temperature over the secondary and tertiary heat exchange sections sufficiently to prevent freezing in the condensing sections and provide for higher turndown operation.

Additionally, by introducing the secondary heat exchanger assembly 20 having corrosive-resistant material, condensing may occur not just in the tertiary heat exchanger assembly 26 but also in the secondary heat exchanger assembly 20. This configuration allows for lower modulated inputs with airflow 28 provided from outdoor supply air temperatures, especially where constant volume airflow is required (e.g., in building ventilation conditions). As such, the turndown ratio for the condensing furnace 10 may be about 5 to 1 or higher.

Provided is a method and condensing furnace assembly that is configured to reduce the risk of condensate freezing within the heat exchanger assemblies. Additionally, the condensing furnace assembly is designed such that the airflow directed across the tubes of the primary, secondary, and tertiary heat exchanger assemblies may be bi-directional to provide flexibility of design with the ventilation system that is to utilize the condensing furnace assembly therein. The bi-directional capability of this method and assembly allows for the ventilation system design flexibility while maintaining a turndown ratio of about 5:1 while reducing the risk of condensate freezing.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The features of each embodiment described and shown herein may be combined with the features of the other embodiments described herein. The claims as follows are intended to include all modifications and alterations insofar as they come within the scope of the claims or the equivalent thereof

Having thus described the invention, I claim:

1. A method of operating a condensing furnace assembly to heat an external airflow directed into a conditioned space, wherein the condensing furnace assembly is located external to the conditioned space, the method comprising:
directing heated combustion gases through a primary heat exchanger assembly, a second stage supplemental heat exchanger assembly, and a condensing stage heat exchanger assembly; where:
the primary heat exchanger assembly comprises a plurality of aligned tubes, wherein each of the plurality of aligned tubes defines a U-shaped configuration comprising a first straight portion in fluid communication with combustion products from the burner assembly, a second straight portion spaced apart from and parallel to the first straight portion, and a connective portion perpendicular to and connecting the first and second straight portions;
the second stage supplemental heat exchanger assembly and the condensing stage heat exchanger are disposed interior to and surrounded by the U-shaped configuration of the plurality of aligned tubes of the primary heat exchanger, where the second stage supplemental heat exchanger assembly and the condensing stage heat exchanger assembly are oriented such that external airflow traversing over the heat exchanger is in one of the following directions:
(i) over the external surfaces of the first straight portion of the primary heat exchanger tubes, over the external surfaces of condensing stage heat exchanger assembly, over the external surfaces of the second stage supplemental heat exchanger assembly, and then over the external surfaces of the second straight portion of the primary heat exchanger, or
(ii) over the external surface of the second straight portion of the primary heat exchanger, over the external surfaces of the second stage supplemental heat exchanger, over the external surfaces of the condensing stage heat exchanger, and then over the first straight portion of the primary heat exchanger; and
an external airflow having a temperature below freezing entering in direction (i) or (ii), wherein: (a) when the external airflow passes in direction (i), the first pass of the primary heat exchanger heats the external airflow to a temperature sufficient such that temperature in the condensing stage heat exchanger is above the freezing point of condensate formed within the condensing stage heat exchanger; or (b) when the external airflow passes in direction (ii), the second straight portion of the primary heat exchanger and the second stage supplemental heat exchanger assembly heat the external airflow to a temperature such that a temperature within the condensing stage heat exchanger is above the freezing point of condensate formed within the condensing stage heat exchanger.

2. The method of operating a furnace assembly of claim 1 further comprises modulating the burner assembly to combust gas above a dew point temperature of exhaust gases wherein the combustion gases are introduced into and through the primary heat exchanger and second stage supplemental heat exchanger assemblies above the dew point temperature while the airflow traverses over the heat exchanger assembly.

3. The method of operating a furnace assembly according to claim 1, wherein the temperature of the external airflow entering over the primary heat exchanger assembly is less than 0° F.

4. The method of operating a furnace assembly according to claim 1 further comprising a combustion air device to draw the combustion gases through the primary heat exchanger assembly, second stage supplemental heat exchanger assembly, and condensing stage heat exchanger assembly such that the combustion gases are exhausted from the furnace assembly.

5. The method of operating a furnace assembly according to claim 4, wherein a portion of the combustion gas is converted into the condensate liquid within the condensing heat exchanger.

6. The method of operating a furnace assembly according to claim 5, wherein condensate within the second stage supplemental heat exchanger does not occur when the temperature of the external airflow flowing over the primary heat exchanger assembly is below freezing.

7. The method of operating a furnace assembly according to claim 1 further comprises maintaining operation of the condensing furnace at a turndown ratio of about 5:1.

8. A condensing furnace comprising:
a burner assembly, a manifold assembly, and a combustion air device;
a primary heat exchanger assembly comprising a plurality of aligned tubes, wherein each of the plurality of aligned tubes defines a U-shaped configuration comprising a first straight portion in fluid communication with combustion products from the burner assembly, a second straight portion spaced apart from and parallel to the first straight portion, and a connective portion perpendicular to and connecting the first and second straight portions;
a second stage supplemental heat exchanger assembly; and
a condensing stage heat exchanger assembly;
the second stage supplemental heat exchanger assembly and the condensing stage heat exchanger being each being disposed interior to and surrounded by the U-shaped configuration of the plurality of aligned tubes of the primary heat exchanger, where the second stage supplemental heat exchanger assembly and the condensing stage heat exchanger assembly are oriented such that external airflow traversing over the heat exchanger is in one of the following directions:
(i) over the external surfaces of the first straight portion of the primary heat exchanger tubes, over the external surfaces of condensing stage heat exchanger assembly, over the external surfaces of the second stage supplemental heat exchanger assembly, and then over the external surfaces of the second straight portion of the primary heat exchanger, or
(ii) over the external surface of the second straight portion of the primary heat exchanger, over the external surfaces of the second stage supplemental heat exchanger, over the external surfaces of the condensing stage heat exchanger, and then over the first straight portion of the primary heat exchanger, such that the external airflow temperature is heated to a temperature above the freezing point of condensate formed within the condensing stage heat exchanger assembly whether the external airflow is in direction (i) or (ii).

9. The condensing furnace according to claim 8, wherein the second stage supplemental heat exchanger assembly is an intermediate single-pass tubular heat exchange section made from a stainless steel alloy.

10. The condensing furnace according to claim 8, wherein the condensing stage heat exchanger assembly is a single-pass tubular heat exchanger section with a stainless steel alloy.

11. The condensing furnace according to claim 10, wherein the condensing stage heat exchanger assembly includes a tube having a plurality of fins.

12. The condensing furnace according to claim 8, wherein the turndown ratio of the condensing furnace is about 5 to 1.
